(19) United States
(12) Patent Application Publication
(10) Pub. No.: US 2015/0083225 A1
(43) Pub. Date: Mar. 26, 2015

(54) TITANIA MICROSTRUCTURE IN A DYE SOLAR CELL

(71) Applicants: Barry Breen, Jerusalem (IL); Izhak Barzilay, Ramat Yishai (IL); Boris Brudnik, Haifa (IL); Jonathan R. Goldstein, Jerusalem (IL)

(72) Inventors: Barry Breen, Jerusalem (IL); Izhak Barzilay, Ramat Yishai (IL); Boris Brudnik, Haifa (IL); Jonathan R. Goldstein, Jerusalem (IL)

(21) Appl. No.: 14/318,695

(22) Filed: Jun. 30, 2014

Related U.S. Application Data
(63) Continuation-in-part of application No. PCT/IB12/02807, filed on Dec. 28, 2012.

(30) Foreign Application Priority Data
Dec. 28, 2011 (GB) 1122379.9

(51) Int. Cl. H01G 9/20

(52) U.S. Cl. CPC H01G 9/2031; H01G 9/2059; Y10S 977/948
USPC 136/263; 438/93

(57) ABSTRACT

A photovoltaic dye cell including a cell housing having an at least partially transparent cell wall; an electrolyte, disposed within the housing, and containing a charge transfer species; an at least partially transparent electrically conductive layer disposed on a first interior surface of the cell wall, within the photovoltaic cell; an anode disposed on the electrically conductive layer, the anode including: (i) a sintered porous film containing sintered titania, the film disposed on a broad face of the electrically conductive layer, and adapted to make intimate contact with the electrolyte, and (ii) a dye, absorbed on a surface of the porous film, the dye and the porous film adapted to convert photons to electrons, by means of the charge transfer species; and a cathode disposed substantially opposite the anode, and including a catalytic surface disposed to contact the electrolyte; wherein the film has an overall average pore size (d₅₀) falling within a range of 25 to 45 nanometers, contains less than 700 ppm carbon, and has an at least bi-modal pore size distribution in which a first mode has an average pore size of at most 23 micrometers, and in which a second mode has an average pore size of at least 25 micrometers.

### CROSS-REFERENCE TO RELATED APPLICATIONS

This patent application is a continuation of PCT Application No. PCT/IB2012/002807, which claims priority from UK Patent Application No. GB1122379.9, filed on Dec. 28, 2011, both of which applications are hereby incorporated in entirety by reference.

### BACKGROUND OF THE INVENTION

Dye solar cells (DSCs) may offer a relatively inexpensive alternative to conventional silicon and thin film photovoltaic cells on the basis of materials, process costs and plant capital expenditures. While various photovoltaic systems require complex vacuum deposition processes, dye cells may be constructed using simple screen printing of pastes followed by oven treatment in air. A general description of a dye cell following its invention by Graetzel and O'Regan in 1991 has been provided in our issued U.S. Pat. No. 7,737,356 to Goldstein, which application is hereby incorporated in entirety by reference. More recent dye cell constructions may have a nanosized mesoporous anatase titania layer stained with a sensitizing dye (the photoanode), a layer of redox electrolyte (where the redox component may be based on an iodine or a cobalt species) and a catalytic cathode that often contains high surface area carbon.

To achieve superior endurance, dye cells may be sealed in glass and the titania is supported on one of the glass sheets; these sheets may be made electrically conductive by means of a thin, transparent conducting tin oxide (CTO) layer. A schematic diagram of a typical dye solar cell device 100 is provided in FIG. 1. FIG. 1 shows a photoanode 10 facing a light source 6, the photoanode including an at least semi-transparent cell wall 8 (e.g., a glass or plastic cell wall) having an at least semi-transparent or transparent conductive coating or layer 12 (e.g., a tin oxide layer or doped tin oxide layer) carrying a titania layer 14 stained with sensitizing dye; a redox electrolyte (e.g., as a redox electrolyte layer 16); and a catalytic cathode 20 including a catalyst layer 22 (typically made of platinum or catalytic carbon) facing photoanode 10, and a conductive layer 24 distal to photoanode 10. Device 100 may supply power to a load 26 in an external circuit 28, as shown. The titania in layer 14 may include a high surface area support for the sensitizing dye. The thickness of layer 14 may typically be about 10 micrometers, and may advantageously have a sintered porous structure, the bulk density of which may be about 50% of the density of the titania crystal. Layer 14 may include, or consist largely of, nanocrystalline particles of about 20 nm in diameter. The pores within layer 14 may also have a diameter of around 20 nm. Conversion efficiencies of photovoltaic dye cells of this type have reached over 12% for small champion research cells and over 8% for small prototype sub-modules (in 2011) by optimizing the different cell components and the fabrication methods. Further improvements, however, may necessitate new concepts to overcome limitations inherent in the standard cell.

A well-known dye cell performance restriction arises from the following principles:
(1) efficient photo-induced charge separation requires direct contact between the light absorber (the dye) and the titania surface;
(2) the geometry of the nanoporous oxide photoelectrode and the diffusion length of electrons in the electrode limit the surface area that can be used for the adsorption of dye molecules.
   Consequently, there is not enough electrode surface area to allow extension of the spectral response of the cell (e.g., by dye mixtures). In other words, the effective surface area of the nanoporous electrodes may largely define the portion of the solar radiation that is utilized by the cell.

In previous applications, we have described methods and materials to solve problems of scale-up of dye cells and have developed large area, full commercial size glass dye cells having robust, silver-free current collectors. We believe these cells to be the largest dye cells built to date, which cells provide a record 3A short current circuit at one sun illumination. Such cells are electrically connected in series on a support structure to provide large area modules. Despite the good cost prognosis referred to above, in order to enter the large on-grid market and compete effectively, we believe that DSC module efficiencies may need to be improved to at least 10%.

PCT Publication No. WO2011/089611 to Zaban reports an improved module efficiency. The new approach, based on the Foerster Resonance Energy Transfer (FRET) effect, involves the use of dye (acceptor molecules) and quantum dots (donor molecules), both carried on the titania in close-placed orientation, working together in the dye cell. The quantum dots are believed to act as antennae that collect photons from a large wavelength fraction (i.e., a fraction exceeding that of the dye alone) of the solar spectrum, convert the photons to energy, and transfer that energy in radiation-free dipole-dipole interactions to the dye for the charge separation process in the cell.

The setup disclosed in WO2011/089611 is shown schematically in FIG. 1A. The quantum dots are shown as donor (of the excitation energy) molecules 132 disposed on a porous titania support 134 and are covered with a thin impervious coating (typically of amorphous titania) 136 intended to prevent corrosion of the quantum dot (donor molecules 132) by cell electrolyte 138.

Porous titania support 134 may be supported by an at least semi-transparent conductive layer 112. Light source 6 directs light through layer 112 and into the layer containing porous titania support 134.

The dye molecules, which serve as acceptors 140 (of the excitation energy), are disposed on coating 136, which may be placed at a distance less than 10 nm from the quantum dots, a condition for the FRET effect to occur). In this configuration, the quantum dot is the main light absorber, and the dye is released from its normal light absorption task, needing primarily to have good electron injection properties into the titania.

FIG. 2 provides a plot of the accumulated photocurrent (in mA/cm²) as a function of wavelength. The solar spectrum photon flux (s⁻m²) is also plotted as a function of wavelength.

From these plots, the potential contribution of quantum dots to light absorption is clear. By way of example, a typical red ruthenium dye (such as N719) will absorb only out to about 650 nm, which limits the cell output. By use of quantum dots, which absorb well up to 900 nm, and using dyes to match the quantum dots which absorb further into the near infra red than N719, the current response may be appreciably increased, and cell efficiency is boosted.

In this system, the dye receives energy needed for cell operation via two paths:
(1) direct absorption of photons; and
(2) as energy that is transferred from the antennae.
   Both paths result in excitation of an electron in the dye and sequential charge separation. Selection of the spectral response of the dye and the type of antennae enable coverage of a much wider window of the solar spectrum. In addition, the antennae, which do not participate in the photo-electrochemical window, may have a high absorption coefficient and a wide spectral response. Thus, relative to a standard dye cell having the same mesoporous titania based photoelectrode, optical density and spectral response may be increased.

### SUMMARY OF THE INVENTION

According to one aspect of the present invention there is provided a photovoltaic dye cell including: (a) a cell housing, the housing including an at least partially transparent cell wall; (b) an electrolyte, disposed within the housing, the electrolyte containing a redox charge transfer species; (c) an at least partially transparent electrically conductive layer disposed on a first interior surface of the cell wall, within the photovoltaic cell; (d) an anode disposed on the at least partially transparent electrically conductive layer, the anode including: (i) a sintered porous film containing sintered titania, the film disposed on a broad face of the electrically conductive layer, and adapted to make intimate contact with the electrolyte, and (ii) a dye, absorbed on a surface of the porous film, the dye and the porous film adapted to convert photons to electrons, by means of the charge transfer species; (e) a cathode disposed within the cell housing, substantially opposite the anode, the cathode including a catalytic surface disposed to fluidly contact the electrolyte; the sintered porous film having an overall average pore size (d₅₀) falling within a range of 25 to 45 nanometers, the sintered porous film containing less than 700 ppm carbon, the sintered porous film having an at least bi-modal pore size distribution in which a first mode of the distribution has an average pore size of at most 23 micrometers, and in which a second mode of the distribution has an average pore size of at least 25 micrometers.

According to another aspect of the present invention there is provided a photovoltaic dye cell for converting a light source into an electrical current, the cell including: (a) a cell housing, the housing including an at least partially transparent cell wall; (b) an electrolyte, disposed within the housing, the electrolyte containing a redox charge transfer species; (c) an at least partially transparent electrically conductive layer disposed on a first interior surface of the cell wall, within the photovoltaic cell; (d) an anode disposed on the at least partially transparent electrically conductive layer, the anode including: (i) a sintered porous film containing sintered titania, the film disposed on a broad face of the electrically conductive layer, and adapted to make intimate contact with the electrolyte, and (ii) a dye, absorbed on a surface of the porous film, the dye and the porous film adapted to convert photons to electrons, by means of the charge transfer species; and (e) a cathode disposed within the cell housing, substantially opposite the anode, the cathode including a catalytic surface disposed to fluidly contact the electrolyte; the sintered porous film having an average pore size falling within a range of 25 to 45 nanometers, the sintered porous film containing less than 700 ppm carbon, the sintered porous film including at least one secondary material containing a metal, the metal having a concentration within a range of 10 ppm to 1000 ppm, the metal being selected from the group of metals consisting of zinc, magnesium, and aluminum.

According to yet another aspect of the present invention there is provided a method of producing a photovoltaic dye cell, the method including: (a) screen printing, onto a conductive layer of an at least partially transparent cell wall, a titania paste containing titania particles having an average particle size of less than 50 nanometers, and pore former particles having an average particle size of 20 nanometers to 300 nanometers; (b) subsequent to step (a), sintering the titania paste disposed on the conductive layer, at a temperature of at least 150° C., to produce a rigid, sintered titania layer; (c) subsequent to step (b), dissolving the pore former particles from the sintered layer to produce enlarged pores within the sintered titania layer; (d) staining the sintered titania layer with at least one dye, to produce a stained anode; (e) assembling the stained anode, a catalytic cathode and an electrolyte containing a charge transfer species; and (f) sealing the stained anode, the catalytic cathode and the redox electrolyte to produce the photovoltaic dye cell.

According to further features in the described preferred embodiments, the range of the overall average pore size is within a range of 25 nanometers to 40 nanometers, 25 nanometers to 35 nanometers, 30 nanometers to 35 nanometers, or 25 nanometers to 30 nanometers.

According to still further features in the described preferred embodiments, the pores within the second mode have an average length to diameter ratio of up to 2:1, up to 1.75:1, up to 1.5:1 or up to 1.3:1.

According to still further features in the described preferred embodiments, the first mode has an average pore size of at most 22 micrometers, at most 21 micrometers, or at most 20 micrometers.

According to still further features in the described preferred embodiments, the second mode has an average pore size of at least 27 micrometers, at least 30 micrometers, at least 35 micrometers, at least 45 micrometers, at least 70 micrometers, at least 100 micrometers, or at least 150 micrometers.

According to still further features in the described preferred embodiments, the pore size distribution ratio, defined by a number of particles of the second mode divided by a total number of particles of the first mode and second mode, is at least 25%, at least 35%, at least 40%, at least 50%, at least 60%, or at least 70%. According to still further features in the described preferred embodiments, the pore area ratio is at most 90%.

According to still further features in the described preferred embodiments, the sintered porous film contains less than 675 ppm carbon, less than 600 ppm carbon, less than 500 ppm carbon, less than 400 ppm carbon, or less than 250 ppm carbon.

According to still further features in the described preferred embodiments, the sintered porous film includes a metal or secondary metal oxide having a concentration within a range of 10 ppm to 1000 ppm, the metal selected from the group of metals consisting of zinc, magnesium, and aluminum, the metal oxide selected from the group of metal oxides consisting of zinc oxide, magnesium oxide, and aluminum oxide. According to still further features in the described preferred embodiments, the concentration being at least 15 ppm, at least 20 ppm, at least 25 ppm, at least 35 ppm, at least 50 ppm, at least 75 ppm, or at least 100 ppm.

According to still further features in the described preferred embodiments, the sintered porous film includes zinc or zinc oxide in a concentration within a range of 10 ppm to 1000 ppm.

According to still further features in the described preferred embodiments, the concentration of the metal or metal oxide is less than 700 ppm, less than 500 ppm, less than 300 ppm, less than 200 ppm, less than 150 ppm, less than 100 ppm, less than 75 ppm, less than 50 ppm, or less than 30 ppm.

According to still further features in the described preferred embodiments, the pores within the sintered porous film contain quantum dots or encapsulated quantum dots.

According to still further features in the described preferred embodiments, the pores contain encapsulated quantum dots having a diameter of at least 10 nanometers, at least 12 nanometers or at least 15 nanometers.

According to still further features in the described preferred embodiments, the sintered porous film having a bottom face contacting the electrically conductive layer, and a top face facing the anode, and a thickness T, the sintered porous film having a top layer consisting of a top 10% of the thickness T, an intermediate layer consisting of an intermediate 10% of the thickness T, and a bottom layer consisting of a bottom 10% of the thickness T, wherein a population of the quantum dots within the bottom layer equals at least 3%, at least 5%, at least 10%, at least 20%, at least 30%, or at least 50% of a population of the quantum dots within the top layer.

According to still further features in the described preferred embodiments, the population of the quantum dots or the encapsulated quantum dots within the intermediate layer equals at least 5%, at least 10%, at least 20%, at least 30%, at least 50%, at least 60%, or at least 75%, of a population of the quantum dots within the top layer.

According to still further features in the described preferred embodiments, the sintered porous film containing the sintered titania has structural features associated with high-temperature sintering at a temperature of at least 370° C., at least 400° C., at least 425° C., at least 435° C., at least 450° C., at least 465° C., at least 480° C., at least 500° C., at least 520° C., or at least 550° C.

According to still further features in the described preferred embodiments, the metal includes, or consists mainly of, zinc.

According to still further features in the described preferred embodiments, the method further includes implanting quantum dots within the enlarged pores. According to still further features in the described preferred embodiments, the sintering is performed at a temperature of at least 370° C.

According to still further features in the described preferred embodiments, the redox charge transfer species are selected from the group consisting of an iodine-based redox species and a cobalt-based redox species.

According to still further features in the described preferred embodiments, the pore former particles have an average particle size within a range of 20 to 250 nanometers, 20 to 200 nanometers, 20 to 150 nanometers, 20 to 100 nanometers, 20 to 70 nanometers, 20 to 50 nanometers, 25 to 300 nanometers, 25 to 100 nanometers, 30 to 300 nanometers, or 30 to 100 nanometers.

According to still further features in the described preferred embodiments, the pore former particles include a metal oxide selected from the group of oxides consisting of zinc oxide, magnesium oxide, and aluminum oxide.

According to still further features in the described preferred embodiments, steps (a) to (c) of the method are performed to obtain an overall average pore size (d₅₀) within a range of 25 nanometers to 40 nanometers, 25 nanometers to 35 nanometers, 30 nanometers to 35 nanometers, or 25 nanometers to 30 nanometers.

The inventive sintered porous film may be advantageous for various photovoltaic dye cells. However, the pores within the sintered porous film may be particularly suitable for containing quantum dots or encapsulated quantum dots.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic diagram of a typical dye solar cell device that may be used or manufactured in accordance with the present invention;

FIG. 1A is a schematic diagram showing dye molecules and quantum dots disposed on titania in a close-placed orientation, working together in a dye cell that may be used or manufactured in accordance with the present invention;

FIG. 2 provides a plot of accumulated photocurrent and solar spectrum photon flux as a function of wavelength;

FIG. 3 provides a SEM image in which quantum dots are disposed in pores within the titania layer, according to the present invention;

FIG. 4 provides a SEM image of sintered, non-etched titania, in which, within the tight pored structure, penetration of quantum dots is diminished or unobserved; and

FIG. 5 provides a schematic representation of a bi-modal pore size distribution within a sintered titania layer in the photovoltaic cell of the present invention.

### DESCRIPTION OF THE PREFERRED EMBODIMENTS

In one aspect of the present invention, we introduce removable, non-organic, typically spherical pore-formers into current titania screen printing pastes such that on paste application and sintering the pore former is removed in-situ or can be removed by an additional process, either way leaving behind a titania layer having expanded pores. By using non-organic pore formers, essentially no organic or carbon residues may remain in the titania following pore former removal. Such impurities may cause severe recombination of charge carriers in the cell and consequent loss of cell efficiency.

After pore-former removal (by various methods, including etching, vaporizing, dissolving etc.), advantageous larger diameter pores are left behind in the titania, whereby embedding of quantum dots in the titania is facilitated. This strategy of pore expansion in titania may also be used to enhance take-up of difficult electrolytes (e.g., ionic liquids, solid electrolytes, or liquid-phase electrolytes having large-diameter redox species with respect to iodine-based redox species) into titania photoanodes, or large dye molecules during titania staining procedures. Of the inventive pore-enlarging methods disclosed herein, we have found that inclusion of zinc oxide in the paste and etching (following sintering of the paste) by means of dilute hydrochloric acid to be of particular advantage. Due to the chemical stability of titania to acid, alkali and neutral solutions, etching using other material combinations (particular pore-formers along with etching materials selected to etch each particular pore former) may be used. Non heavy metal and non-transition metal oxides may be preferred as pore formers, since they may contaminate the titania to a lesser degree. For acid etching, magnesium oxide may be a good alternative to zinc oxide, and for alkali etching (for example, using dilute sodium hydroxide), zinc oxide or aluminum oxide may be used. Additionally, dissolution may be possible using simple salt pore-formers such as magnesium sulfate, which is removable with water. Such salts must be insoluble or substantially insoluble in the paste vehicle and thermally stable up to the temperature at which the titania is sintered.

A potentially advantageous feature of using zinc oxide as the pore former is that the zinc oxide traces remaining in the titania (i.e., not removed by the etching process) do not appear to reduce cell performance. Moreover, if such zinc oxide traces are corroded or chemically altered by the cell electrolyte (for example by iodine), trace quantities of zinc ion entering the electrolyte may not detract or appreciably detract from cell performance. In fact, small traces of zinc or zinc oxide may be present in the raw materials of the titania paste, typically less than 2 or 2.5 ppm, based on chemical analysis of a large number and types of titanium-based materials that are suitable for producing sintered titania layers for dye cells.

In the dye cells and methods of the present invention, the concentration of zinc, in any form, within the sintered titania layer of the dye cell (or within the cell electrolyte fluidly communicating therewith), may be at least 5 ppm, at least 7 ppm, or at least 10 ppm. This concentration of zinc may be within a range of 5-1000 ppm, 7-1000 ppm, 10-1000 ppm, 5-500 ppm, 7-500 ppm, 10-500 ppm, 12-1000 ppm, or 15-1000 ppm, and more typically, within a range of 10-300 ppm or 10-100 ppm.

These ranges apply to the concentrations of magnesium and aluminum within the sintered titania layer of the dye cell (or within the cell electrolyte fluidly communicating therewith), when the pore former is magnesium-based (e.g., MgO) or aluminum-based (e.g., Al₂O₃). While minor traces of magnesium or aluminum (presumably as oxides) may be present in the raw materials of the titania paste, the concentrations are extremely low (typically less than 2 ppm for aluminum, often somewhat less for the magnesium), based on chemical analysis of a large number and types of titanium-based materials that are suitable for producing sintered titania layers for dye cells.

Thus, sintered titania layers in the dye cells of the present invention may be distinguished from known sintered titania layers by a significantly higher concentration of zinc, aluminum, and/or magnesium, with respect to the concentrations of those metals in the known sintered titania layers.

US Patent Publication 2006/0102226 to Kern et al., discloses elongated pore former molecules that are introduced into the titania sintering paste in order to give a sintered titania with enlarged pore structure for enhanced electrolyte diffusion. In paragraph [0007], it is disclosed that the particles are burnt out, leaving elongated cavities at the titania sintering temperature, and in paragraph [0011], the particles are described as typically fibrous, fabric or plastics, in other words, organic/polymeric molecules. In paragraph [0023], the pore-former disclosed is polymer nanotubes of block copolymers.

The inventive method utilizes solely inorganic pore formers. Such pore formers may advantageously be removed by etching or dissolution, such that problematic carbon traces in the titania—an inevitable outcome of the burnout process with polymers and a cause of recombination and efficiency losses in the cell—is avoided. Moreover, upon polymer burnout, gases (e.g., carbon dioxide, water vapor) may be released into the still semi-plastic titania screen-printing paste, before the sintering temperature is reached. This gas release may damage the anode structure and titania connectivity, and produce pores of disadvantageous shape and dimensions. By comparison, the present invention utilizes an etchable or dissolvable pore former that typically remains in place as a solid, even after the sintering step has been completed, and the titania has assumed a rigid porous structure. The pore former may then be removed without appreciable change or damage to the structure.

In addition, the pore former materials used in the method of the present invention may essentially be spherical powders preferably having a length to diameter ratio of up to 2:1, up to 1.75:1, up to 1.5:1, or up to 1.3:1. The elongated polymers disclosed by US Patent Publication 2006/0102226, which are vital to provide elongated cavities that enhance electrolyte diffusion within the titania, may be fundamentally unsuitable to the titania structure of the present invention.

One aspect of the present invention is a method of producing a photovoltaic dye cell, including: (a) screen printing, onto a conductive layer of an at least partially transparent cell wall, a titania paste containing titania particles having an average particle size of less than 50 nanometers, and containing pore former particles having an average particle size of 20 nanometers to 300 nanometers; (b) subsequent to step (a), sintering the titania paste disposed on the conductive layer, at a temperature of at least 150° C., to produce a rigid, sintered titania layer; (c) subsequent to step (b), dissolving the pore former particles from the sintered layer to produce enlarged pores within the sintered titania layer; (d) staining the sintered titania layer with at least one dye, to produce a stained anode; (e) assembling the stained anode, a catalytic cathode and an electrolyte containing a charge transfer species; and (f) sealing in these components to produce the photovoltaic dye cell.

The resulting sintered titania layer has a low concentration of carbon, and may contain traces of zinc, aluminum, and/or magnesium, as described hereinabove. This sintered layer may also be structurally characterized by an inventive bi-modal pore size distribution, as will be described in further detail hereinbelow.

According to a further embodiment, the dissolving may include etching. According to a further embodiment, the dissolving may include dissolving in water or in an aqueous solution.

The methods and titania structures of the present invention may take up of quantum dots by the titania photoanode for enabling FRET efficiency-boosting in dye solar cells. Most quantum dots, if not suitably protected, may be attacked chemically by the iodine-based (or other) redox electrolyte. The quantum dot may be covered with a layer of amorphous titania. Alternatively, the quantum dot may be protected by encapsulation, for example, using a non-porous layer of silica or silica-based compositions. Such encapsulated quantum dots can be fairly large, having diameters of about 15 nm or more. It is difficult to introduce such large diameter quantum dots homogeneously into the normally tight-pored titania, in which pore sizes are typically of the order of 20 nm.

### EXAMPLES

Reference is now made to the following examples, which together with the above description, illustrate the invention in a non-limiting fashion.

### Example 1

An example of one embodiment of the inventive method and dye cell is now provided:

A 500 g batch of viscous solution was made from terpineol and ethyl cellulose in a 10:1 weight ratio and was mixed for two hours using a mechanical mixer. A 135 g portion of the batch was placed in a 0.5 liter jar made of zirconia. To this was added 15 g titania powder type P90 (Degussa) including 12 nm size anatase particles, 2.4 gm acetyl acetone (Aldrich), 36 gm Tyzor type AA105 titania precursor (Dupont) including a organic titanate in alcoholic solution, and 21 g of a spherical, 20 nm diameter zinc oxide powder (Aldrich). After stirring to uniformity, twelve zirconia balls (15 mm diameter) were added to the jar, the jar was sealed and ball milling carried out for six hours with cooling stops every hour. After this, the titania mixture was put through a three-roll mill until a viscous paste was formed.

The paste was screen-printed onto a 15 cm×15 cm×3 mm tin oxide coated glass plate using a 200 mesh stainless steel screen and a Dek Model 247 screen printer. Two titania layers were applied, with drying performed at 100° C. for 10 minutes after each layer application, and then the plate was passed through a Hengli (Hengli Eletek Co., Ltd., China) belt oven, where the plate was subjected to sintering in air (to 475° C.) for 30 minutes. The sintered titania layer was about 12 microns thick. The titania plate was then immersed in an etching solution to remove the zinc oxide. The etching solution contained 0.7 wt % hydrochloric acid in deionized water. Following etching for 15 minutes, the plate was transferred to a fresh etching bath for a further 15 minutes, and washed with excess deionized water until substantially no acid remained. The plate was then dried with an air jet.

### Example 2

A first control paste was prepared with no zinc oxide and printed and sintered in the same manner as the paste containing zinc oxide.

### Example 3

A second control paste was prepared with 20 wt % (on a titania basis) polystyrene balls (20 nm) as an organic pore former and sintered in the same manner as the paste containing zinc oxide.

### Example 4

Samples of a titania film, produced in accordance with the present invention, were gently scraped from a glass support. Analysis of the specific surface area of the titania powder obtained was performed using nitrogen adsorption in conjunction with the Brunauer-Emmett-Teller (BET) method. Pore measurements were performed using mercury porosimetry.

The surface area of the etched sample was somewhat smaller than that of the unetched sample (100 square meters per gram versus 110 square meters per gram), but the average pore size was increased from around 20 nm for the unetched sample to about 40 nm for the etched sample. This structure was confirmed by SEM measurements.

The carbon content of the sintered titania with or without zinc oxide was below the detection limit of 500 ppm. By sharp contrast, the sample prepared with polystyrene pore former had a carbon content of 1500 ppm. Residual zinc in the etched sample was approximately 100 ppm.

### Example 5

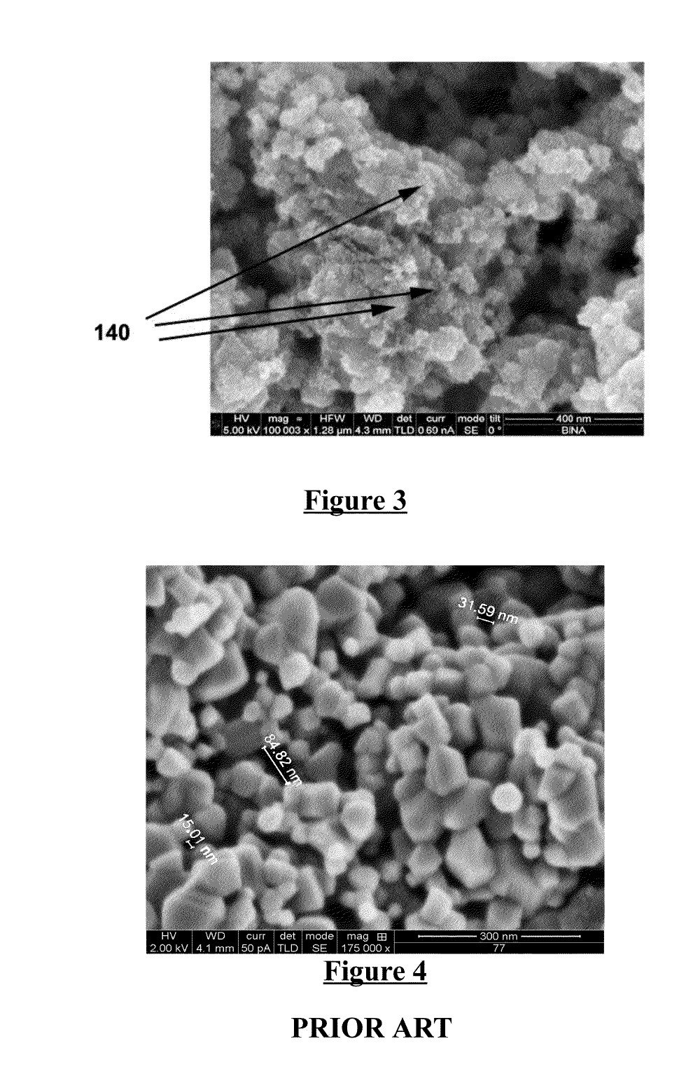

Take up of quantum dots by the titania anodes was checked using a laser probe and by SEM microscopy. The exemplary quantum dots used were of the CdSe core type that had been encapsulated using siloxane and were approximately 14 nm in diameter. The encapsulated quantum dots were provided as a dispersion in cyclohexane (QD Light, Russia). These quantum dots were selected for insertion into porous anodes using electrophoretic deposition. Anodes that had been etched showed good take up of quantum dots following electrophoretic deposition. The anode had a strong orange color and on illumination with a green laser (532 nm) and observing both sides of the anode via a red glass filter, a strong orange-red fluorescence was seen. SEM microscopy also provided evidence of quantum dots disposed in the pores (see FIG. 3). When the same procedure was attempted for non-etched titania, only weak coloration of the anode was observed, with weak fluorescence under laser illumination and no SEM observation of quantum dots in the pores, showing poor pickup of the quantum dots by the tight pored titania.

FIG. 3 is a SEM photograph of the etched sintered titania showing successful quantum dot introduction into the opened pore structure, according to the present invention. FIG. 4 is a SEM image of sintered, non-etched titania, where the tighter pored structure prevented or largely inhibited penetration of quantum dots and hence, their observation.

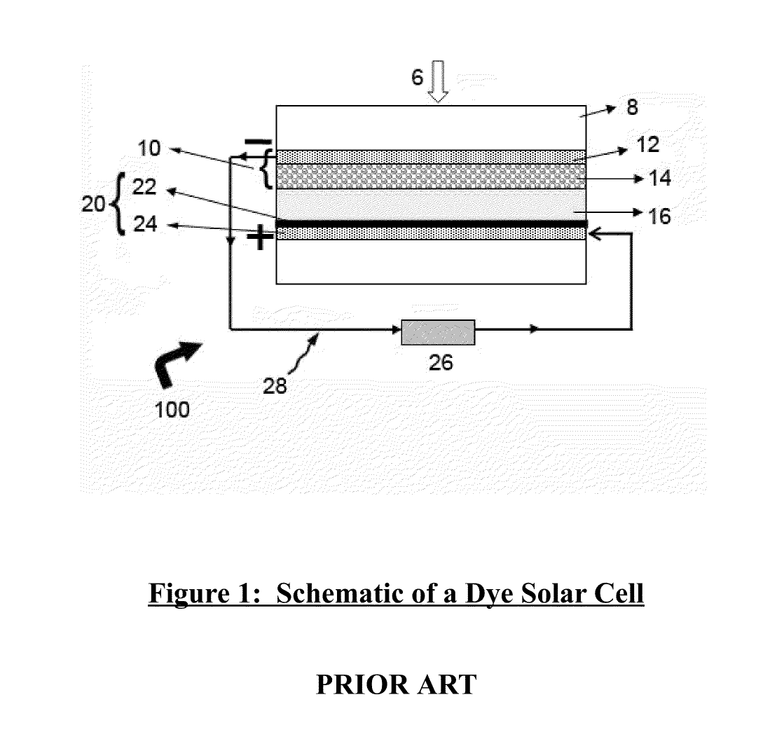

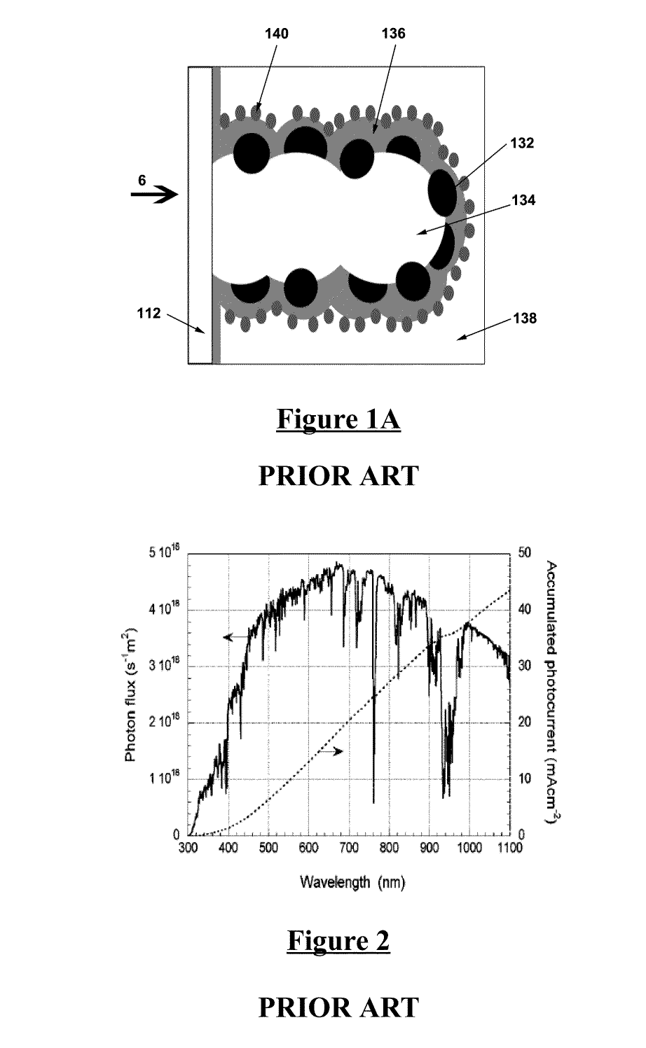

The inventive dye cell may include, substantially as shown in FIG. 1, a cell housing having an at least partially transparent cell wall, typically glass or plastic, such as polyethylene naphthalate (PEN); an electrolyte, disposed within the housing, and containing a charge transfer species (typically a redox species such as an iodine-based or cobalt-based redox charge transfer species); an at least partially transparent electrically conductive layer (typically predominantly containing tin oxide or a doped tin oxide such as a fluorine-doped tin oxide) disposed on a first interior surface of the cell wall; an anode disposed on this transparent electrically conductive layer, the anode including: a sintered porous film containing sintered titania, and adapted to make intimate contact with the electrolyte, and a dye, absorbed on a surface of the porous film, the dye and the porous film adapted to convert photons to electrons, by means of the charge transfer species; and a cathode disposed within the cell housing, substantially opposite the anode, and including a catalytic surface disposed to fluidly contact the electrolyte. The sintered porous film may have an overall average pore size within a range of 25 to 45 nanometers, and may contain less than 700 ppm carbon.

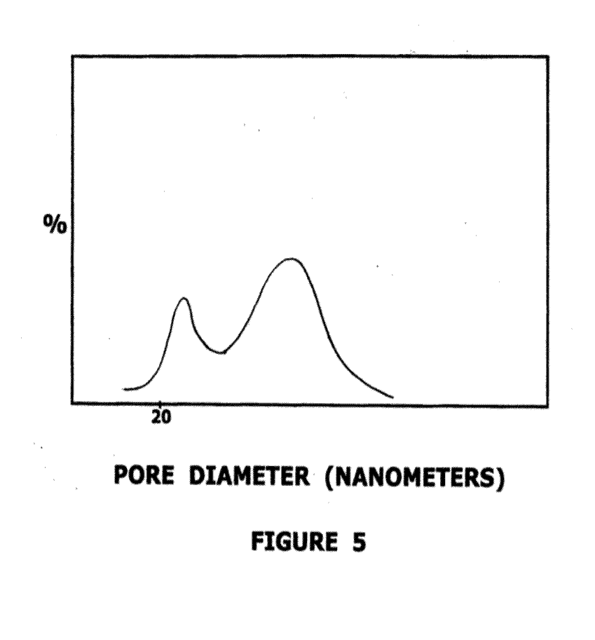

The sintered porous film may have a bi-modal pore size distribution in which a first mode of the distribution has an average (based on number of particles) pore size of at most 23 micrometers, and in which a second mode of the distribution has an average (based on number of particles) pore size of at least 25 micrometers. The first mode may largely be attributed to the “normal” production of pores by means of screen printing the titania paste containing the titania powder and titania precursor (without pore-forming particles such as zinc oxide), followed by sintering. The second mode may largely be attributed to the pores produced by the removal of the pore-forming particles. A schematic representation of such a bi-modal pore size distribution is provided in FIG. 5. The first mode exhibits a peak at about 20 nanometers, while the second mode exhibits a peak at a higher particle size, e.g., 35 or 40 nanometers.

While in some cases, the modes within the distribution may be visually distinct, or easily separable, it will be appreciated that standard measurement techniques, coupled with standard mathematical techniques may be used to quantifiably determine the various statistical parameters, including peak values, d₅₀, relative mode areas, etc., even for overlapping modes.

Typically, the first mode may have an average pore size of at most 22 micrometers, at most 21 micrometers, or at most 20 micrometers, while the second mode has an average pore size of at least 27 micrometers, at least 30 micrometers, at least 35 micrometers, at least 45 micrometers, at least 70 micrometers, at least 100 micrometers, or at least 150 micrometers. The average pore size of the second mode may strongly depend on the average particle size of the pore-forming nanoparticles. Similarly, the pore size distribution of the second mode may strongly depend on the particle size distribution of those pore-forming nanoparticles.

The pores within the sintered porous film may be particularly suited to contain quantum dots or encapsulated quantum dots.

As used herein in the specification and in the claims section that follows, the term “high-temperature sintered”, “undergone high-temperature sintering”, and the like, with respect to a cell component, refers to the structural features of a component that has been heated to at least 370° C., to achieve advantageous structural features in the cell component. Typically, this sintering may be conducted at a temperature of at least 400° C., at least 425° C., at least 435° C., at least 450° C., at least 480° C., at least 500° C., at least 520° C., or at least 550° C. to achieve further advantageous structural features in the cell component.

As used herein in the specification and in the claims section that follows, the term “low-temperature sintered”, “undergone low-temperature sintering”, and the like, with respect to a cell component, refers to the structural features of a component that has been heated to at least 150° C., but less than 370° C., to achieve advantageous structural features in the cell component. Typically, this sintering may be conducted at a temperature of at least 160° C., at least 180° C., at least 200° C., at least 220° C., at least 250° C., at least 300° C., or at least 350° C., to achieve further advantageous structural features in the cell component.

As used herein in the specification and in the claims section that follows, the term “sintered”, “undergone sintering”, and the like, with respect to a cell component, is meant to include both low-temperature sintering and high-temperature sintering.

As used herein in the specification and in the claims section that follows, the term “intermediate layer”, within a sintered porous, titania-containing film, refers to a layer disposed in the middle of the thickness of the sintered film.

As used herein in the specification and in the claims section that follows, the term “metal”, “metal-containing”, and the like, is meant to include all forms of the metal, including metal in ionic form, covalently bonded metal, etc. By way of example, when the metal is zinc, the term “metal” or “zinc” would include zinc oxides, zinc titanates, ionic zincs, and any other form of zinc.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. No. 7,737,356, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-35. (canceled)

36. A photovoltaic dye cell comprising:
(a) a cell housing, said housing including an at least partially transparent cell wall;
(b) an electrolyte, disposed within said housing, said electrolyte containing a redox charge transfer species;
(c) an at least partially transparent electrically conductive layer disposed on a first interior surface of said cell wall, within the photovoltaic cell;
(d) an anode disposed on said at least partially transparent electrically conductive layer, said anode including:
(i) a sintered porous film containing sintered titania, said film disposed on a broad face of said electrically conductive layer, and adapted to make intimate contact with said electrolyte, and
(ii) a dye, absorbed on a surface of said porous film, said dye and said porous film adapted to convert photons to electrons, by means of said charge transfer species;
(e) a cathode disposed within said cell housing, substantially opposite said anode, said cathode including a catalytic surface disposed to fluidly contact said electrolyte;
said sintered porous film having an overall average pore size (d₅₀) falling within a range of 25 to 45 nanometers,
said sintered porous film containing less than 700 ppm carbon,
said sintered porous film having an at least bi-modal pore size distribution in which a first mode of said distribution has an average pore size of at most 23 nanometers, and in which a second mode of said distribution has an average pore size of at least 25 nanometers.

37. The cell of claim 1, said range of said overall average pore size falling within a range of 25 nanometers to 40 nanometers.

38. The cell of claim 1, in which pores within said second mode have an average length to diameter ratio of up to 2:1.

39. The cell of claim 36, in which said first mode has an average pore size of at most 22 nanometers.

40. The cell of claim 36, in which said second mode has an average pore size of at least 30 nanometers.

41. The cell of any claim 36, in which a pore size distribution ratio, defined by a number of particles of said second mode divided by a total number of particles of said first mode and second mode, is at least 25%.

42. The cell of claim 41, in which said pore area ratio is at most 90%.

43. The cell of claim 36, said sintered porous film containing less than 675 ppm carbon.

44. The cell of claim 36, said sintered porous film containing a trace metal having a concentration within a range of 10 ppm to 1000 ppm, said metal selected from the group of metals consisting of zinc, magnesium, and aluminum.

45. The cell of claim 36, said sintered porous film including at least one of zinc and zinc oxide in a concentration within a range of 10 ppm to 1000 ppm.

46. The cell of claim 45, said concentration being at least 50 ppm.

47. The cell of claim 45, said concentration being less than 700 ppm.

48. The cell of claim 36, in which pores within said sintered porous film contain quantum dots or encapsulated quantum dots.

49. The cell of claim 48, in which said pores contain encapsulated quantum dots having a diameter of at least 10 nanometers.

50. The cell of claim 48, said sintered porous film having a bottom face contacting said electrically conductive layer, and a top face facing said anode, and a thickness T, said sintered porous film having a top layer consisting of a top 10% of said thickness T, an intermediate layer consisting of an intermediate 10% of said thickness T, and a bottom layer consisting of a bottom 10% of said thickness T, wherein a population of said quantum dots within said bottom layer equals at least 3% of a population of said quantum dots within said top layer.

51. The cell of claim 50, in which a population of said quantum dots or said encapsulated quantum dots within said intermediate layer equals at least 5% of a population of said quantum dots within said top layer.

52. The cell of claim 36, said sintered porous film containing said sintered titania has structural features associated with high-temperature sintering at a temperature of at least 370° C.

53. A photovoltaic dye cell comprising:
(a) a cell housing, said housing including an at least partially transparent cell wall;
(b) an electrolyte, disposed within said housing, said electrolyte containing a redox charge transfer species;
(c) an at least partially transparent electrically conductive layer disposed on a first interior surface of said cell wall, within the photovoltaic cell;
(d) an anode disposed on said at least partially transparent electrically conductive layer, said anode including:
(i) a sintered porous film containing sintered titania, said film disposed on a broad face of said electrically conductive layer, and adapted to make intimate contact with said electrolyte, and
(ii) a dye, absorbed on a surface of said porous film, said dye and said porous film adapted to convert photons to electrons, by means of said charge transfer species;
(e) a cathode disposed within said cell housing, substantially opposite said anode, said cathode including a catalytic surface disposed to fluidly contact said electrolyte;
said sintered porous film having an average pore size falling within a range of 25 to 45 nanometers,
said sintered porous film containing less than 700 ppm carbon,
said sintered porous film including at least one secondary material containing a metal,
said metal having a concentration within a range of 10 ppm to 1000 ppm, said metal selected from the group of metals consisting of zinc, magnesium, and aluminum.

54. A method of producing a photovoltaic dye cell, the method comprising:
(a) screen printing, onto a conductive layer of an at least partially transparent cell wall, a titania paste containing titania particles having an average particle size of less than 50 nanometers, and pore former particles having an average particle size of 20 nanometers to 300 nanometers;
(b) subsequent to step (a), sintering said titania paste disposed on said conductive layer, at a temperature of at least 150° C., to produce a rigid, sintered titania layer;
(c) subsequent to step (b), dissolving said pore former particles from said sintered layer to produce enlarged pores within said sintered titania layer;
(d) staining said sintered titania layer with at least one dye, to produce a stained anode;
(e) assembling said stained anode, a catalytic cathode and an electrolyte containing a charge transfer species; and
(f) sealing said stained anode, said catalytic cathode and said redox electrolyte to produce the photovoltaic dye cell.

55. The method of claim 54, said pore former particles including a metal oxide selected from the group of oxides consisting of zinc oxide, magnesium oxide, and aluminum oxide.
